(19) United States
(12) Patent Application Publication
(10) Pub. No.: US 2015/0306620 A1
(43) Pub. Date: Oct. 29, 2015

(54) JET-GENERATION APPARATUS AND METHOD FOR GENERATING A LIQUID JET

(71) Applicant: Microliquids GmbH, Goettingen (DE)

(72) Inventors: Manfred FAUBEL, Goettingen (DE); Stephan FIGUL, Goettingen (DE)

(21) Appl. No.: 14/696,800

(22) Filed: Apr. 27, 2015

(30) Foreign Application Priority Data
Apr. 25, 2014 (DE) 10 2014 006 063.2

(51) Int. Cl. B05B 15/04; B05B 9/04; B05B 9/00

(52) U.S. Cl. CPC B05B 15/0406; B05B 9/002; B05B 9/0403; B05B 9/042

(57) ABSTRACT

A jet-generation apparatus (100) adapted to generate a liquid jet (1), includes vacuum chamber (10), nozzle device (20) with at least one nozzle (21, 22), which is arranged for discharging liquid into vacuum chamber (10) and for generation of liquid jet (1), liquid supply device (30) including liquid reservoir (31) and first pump (32) and is coupled to nozzle device (20), collecting device (40) including collecting vessel (41) with inlet opening (42), which is arranged for collecting liquid jet (1) in vacuum chamber (10), and recovery device (50) arranged for recovery of the collected liquid from collecting vessel, wherein recovery device (50) includes second pump (52) arranged between collecting vessel (41) and liquid reservoir (31) and is adapted for the transport of the collected liquid directly into liquid supply device (30). A method for generating a liquid jet (1) with the jet-generation apparatus (100) is also described.

### BACKGROUND OF THE INVENTION

The invention relates to a jet-generation apparatus which is adapted to generate a liquid jet in a vacuum environment, in particular a jet-generation apparatus for providing a target material in the form of a continuous or intermittent liquid jet, e.g. for an interaction with electromagnetic radiation, in particular laser or X-ray radiation, or particle radiation. The invention furthermore relates to a method for generating a liquid jet, in particular with the stated jet-generation apparatus. The invention can be applied in particular with the exposure of liquids to electromagnetic radiation or particle radiation, for example, for the examination of samples or for generating short-wave radiation.

In the explanation of the technical background of the invention, reference is made to the following prior art:

[1] A. Charvat et al. in “Rev. Sci. Instrum.” Vol. 75, 2004, p. 1209-1218;

[2] B. Winter et al. in “Chem. Rev.” Vol. 106, 2006, p. 1176-1211;

[3] WO 2004/110112 A;

[4] B. A. M. Hansson et al. in “J. Phys. D: Appl. Phys.” Vol. 37, 2004, p. 3233 - 3243;

[5] L. Rymell et al. in “Optics Communications” Vol. 103, 1993, p. 105 - 110;

[6] US 2011/0116604 A;

[7] M. Faubel et al. in “Royal Soc. Chem.” Edinburgh 1987, p. 133-136; and

[8] US 2007/0158540 A.

It is generally known to expose laminar liquid jets as a target material, e.g. in the case of mass spectrometry ([1]), photoelectron spectroscopy ([2]) or nanolithography ([3]), to radiation with lasers and/or other radiation sources for photons, X-ray radiation or particle beams. Not only substances which are liquid at room temperature such as water or ethanol, but also liquefied metals or gasses can be used as the liquid. The radiation can strike the liquid before ([4]) or also after ([5]) the Rayleigh disintegration point of the liquid jet into jet segments or into a droplet sequence. The liquid jets typically have a diameter of 0.002 mm to 0.2 mm and flow speeds of up to several hundred meters per second. If lower layer thicknesses of the target material are desired, layered flow structures which have a local minimum of the radius of curvature at least at the location of the irradiation can be generated with the help of two primary jets which join together and collide at an angle ([6]).

M. Faubel et al. were able to show for the first time in 1987 ([7]) that liquid jets can even be stabilized and exposed, for example, to laser radiation in a vacuum (ambient pressure lower than 1 bar). If a liquid is introduced into a vacuum chamber and the liquid is at least partially evaporated, the pressure in the vacuum chamber rises. In order to ensure permanent, stable operation of the liquid jet at low pressure, operation is possible with particularly powerful vacuum pumps which continuously remove gasses from the vacuum chamber. In this complex and costly case, the liquid can, however, not be reused since it is pumped away as vapor.

Reuse of the liquid is, however, often desirable, for example, in order to minimize the consumption of valuable liquids or recover, where applicable, a valuable sample substance in the liquid. It was therefore proposed to collect the liquid in a collecting vessel in the vacuum chamber [8]. The collecting vessel facilitates maintaining the desired low pressure in the vacuum chamber, and at the same time it enables continuous recovery of the liquid from the vacuum chamber. The conventional technique according to [8] has, however, the disadvantage that the vacuum operation must be interrupted for recovery of the liquid from the vacuum chamber in order to remove the collecting vessel from the vacuum chamber or in order to remove the liquid from the collecting vessel. Moreover, a cooling of the collecting vessel is necessary to reduce the vapor pressure of the collected liquid. Cooling, e.g. with liquid nitrogen, represents, however, a high additional outlay.

### DESCRIPTION OF THE INVENTION

The objective of the invention is to provide an improved jet-generation apparatus and an improved method for generating a liquid jet, with which disadvantages and restrictions of conventional techniques are avoided. Jet generation should enable in particular a continuous operation of the jet-generation apparatus without an interruption of the vacuum, enable a simplified structure of the jet-generation apparatus and/or minimize losses of liquid.

These objectives are achieved with a jet-generation apparatus and a method of the invention.

According to a first aspect of the invention, a jet-generation apparatus is provided which is adapted to generate a liquid jet and comprises a vacuum chamber, a nozzle device with at least one nozzle, a liquid supply apparatus with a liquid reservoir and a first pump, and a collecting device, which comprises a collecting vessel with an inlet opening, which is arranged for collecting the liquid jet in the vacuum chamber. The at least one nozzle opens into the vacuum chamber. The liquid supply device is connected via at least one supply line to the at least one nozzle of the nozzle device so that, during operation of the first pump, the liquid is introduced via the at least one nozzle into the vacuum chamber and the liquid jet is generated. A high-pressure pump, such as, for example, an HPLC pump, is preferably used as the first pump for transport of the liquid to the nozzle device. Moreover, the jet-generation apparatus contains a recovery device which is arranged for a recovery of the liquid gathered in the collecting vessel. According to the invention, the recovery device comprises a second pump with which the liquid can be conveyed from the collecting vessel directly into the liquid supply device, in particular into the liquid reservoir. A return line, which includes the second pump, is provided between the collecting vessel and the liquid reservoir, which is also referred to as the collecting vessel.

According to a second aspect of the invention, a method for generating a liquid jet is provided, preferably with the jet-generation device according to the first aspect of the invention, wherein the liquid is supplied from the liquid supply device to the nozzle device, the liquid escapes from the at least one nozzle into the vacuum chamber and forms the liquid jet, in particular a laminar and/or a layered liquid jet, the liquid jet is accommodated in the collecting vessel and the accommodated liquid is recovered. According to the invention, the recovery comprises a transport of the accommodated liquid from the collecting vessel via the second pump directly into the liquid supply device. The liquid is preferably supplied again to the nozzle device with the liquid supply device.

A cycle, which enables a return of the collected liquid to the nozzle device during ongoing operation without an interruption of the vacuum, is advantageously provided with the invention. Losses of liquid are all but ruled out since any potential backflow of liquid vapor out of the collecting vessel into the vacuum chamber is insignificantly small in comparison to the liquid flow via the second pump into the liquid supply device. The liquid gathered with the collecting vessel, which is also referred to as a liquid trap, is pumped away continuously or with predetermined operating cycles with the second pump and used for feeding the jet generation at the nozzle device.

A particular advantage of the invention lies in the fact that a liquid jet, in particular a layered flow structure, can be generated continuously from a liquid storage volume which is significantly reduced in comparison to the volume required in the case of conventional techniques. Preferred applications therefore emerge if the liquid contains particularly valuable dissolved or suspended substances, such as, for example, biological samples, which are only available in small quantities and/or can only be diluted within specific limits. Advantages are therefore achieved in particular for analytical tests in which the liquid with a sample contained therein as the target material is irradiated e.g. with X-ray or laser beams, such as, for example for pump-probe-photo spectroscopy or photoelectron spectroscopy. According to a preferred application of the invention, the method for jet generation therefore comprises the continuous generation of a liquid jet, for example, with a layered flow structure, and the irradiation of the liquid jet with electromagnetic radiation or particle beams.

The invention can advantageously be used with a variety of liquids. The liquid preferably comprises water or an aqueous solution. Alternatively, the invention can, however, also be used with liquefied substances which are gaseous at room temperature and under normal pressure or with liquefied metals.

The type of the second pump of the jet-generation apparatus can be selected in particular as a function of the application of the jet generation and the liquid used. According to a preferred embodiment of the invention, the second pump comprises a peristaltic pump (constriction hose pump). An important advantage of the peristaltic pump lies in the fact that it enables a reliable liquid transport via the pressure difference from the low pressure in the collecting vessel (pressure below 1 bar) to an elevated pressure in the liquid supply device, in particular to the normal pressure (air pressure, atmospheric pressure under normal conditions). The peristaltic pump is tightly sealed off from the side with lower pressure so that it can even build up a vacuum. Further advantages will emerge in case of the recovery of liquids which contain sensitive sample molecules. Only small shear forces which cannot destroy the molecules are generated with the peristaltic pump. Alternatively, a different type of pump, such as e.g. a (micro) piston spray pump or a piezo-diaphragm pump, can be used as the second pump of the jet-generation apparatus.

According to a particularly preferred embodiment of the invention, the second pump, in particular the peristaltic pump, is arranged at the same height as the liquid reservoir of the liquid supply device or above the liquid reservoir in relation to the vertical direction (gravitational direction). Normal pressure preferably prevails in the liquid reservoir so that the liquid conveyed by the second pump can flow freely into the liquid reservoir.

The collecting vessel of the collecting device can be arranged entirely or partially in the vacuum chamber. For collection of the liquid jet, e.g. after an interaction with the electromagnetic radiation or the particle radiation, it is sufficient if an inlet opening of the collecting vessel is arranged in the vacuum chamber. The liquid jet is preferably generated in the vacuum chamber extending in the vertical direction so that the inlet opening is preferably provided in a lower region, for example, at the bottom of the vacuum chamber. The implementation of the invention is, however, not restricted to a vertical alignment of the liquid jet. Alternatively, the liquid jet can also be aligned horizontally or on a different inclination.

The inner diameter of the inlet opening is preferably selected as a function of the outer diameter of the liquid jet so that a backflow of liquid vapor from the collecting vessel into the vacuum chamber is minimized. The inner diameter of the inlet opening is particularly preferably smaller than 10 times, particularly preferably 5 times the outer diameter of the liquid jet. The outer diameter of the liquid jet is determined by the size and arrangement of the at least one nozzle of the nozzle device. The inner diameter of the inlet opening can therefore advantageously be selected as a function of the size and arrangement of the at least one nozzle.

A further advantage of the invention over conventional techniques lies in the fact that no particular demands are placed on the form of the inlet opening. The inlet opening can be e.g. circular, elliptical or rectangular. A backflow of liquid vapor through the inlet opening can be almost entirely prevented as a result of the transporting away with the recovery device so that the particular configuration of the inlet opening, which is described, for example, in [8], and/or the provision of a cooling device on the collecting vessel can be omitted. As a result, the configuration of the collecting vessel can be freely selected as a function of the concrete application of the invention, in particular as a function of the space conditions. It has been shown to be particularly advantageous in practice if the collecting vessel has a cylinder shape (cup shape) or a hose shape.

According to a preferred embodiment of the invention, the jet-generation apparatus can be operated without a cooling of the collecting vessel. It can, however, also be advantageous for special applications of the invention if the collecting vessel is cooled in order to reduce the vapor pressure in the collecting vessel.

According to a further preferred embodiment of the invention, the collecting vessel is provided with a heating device. The heating device particularly preferably comprises a heat pipe heating device (referred to as a “heat pipe”) with which the inlet opening of the collecting vessel can be heated. The heating of the inlet opening has the advantage that the risk of freezing of the liquid in the event of potential contact with the edge of the inlet opening or other parts of the collecting vessel and a resultant interruption of the operation of the jet-generation apparatus is avoided. Temperature-control of the collecting vessel, in particular in the region of the inlet opening, is preferably carried out to a temperature in the range from 0° C. to 250° C., in particular from 20° C. to 200° C., such as, for example, from 40° C. to 150° C. or 60° C. to 120° C.

The heat pipe heating device preferably comprises a tubule, which is thermally coupled to the collecting vessel, being composed of a non-magnetic metal, in particular copper, and through which a heating medium, for example, oil or water vapor flows. The use of the heat pipe heating device in comparison to the resistance heating provided, for example, according to [8] has the advantage than an unintentional influencing of the liquid jet by electric fields is avoided.

According to a further advantageous embodiment of the invention, the liquid supply device can be provided with a refilling connection. The refilling connection comprises a closable opening through which a liquid medium, e.g. the liquid or a solvent for diluting the liquid, can be filled into the liquid reservoir. The refilling connection advantageously enables compensating for any losses of liquid during long-term operation of the jet-generation apparatus and/or varying the liquid which circulates in the jet-generation apparatus (for example, dilution or solvent replacement).

With the method according to the invention, the liquid jet is generated in a vacuum environment with a low pressure in comparison to the normal pressure. A pressure less than or equal to 100 mbar, particularly preferably less than or equal to 10 mbar, such as, for example, less than 6 mbar is preferably present in the vacuum chamber. In order to maintain the low pressure in the vacuum chamber, it is provided with at least one vacuum pump, for example, at least one turbomolecular pump and/or at least one cryopump, wherein pressures of around 10⁻⁵ mbar can preferably be reached.

The nozzle device of the jet-generation apparatus according to the invention preferably has one single nozzle with which the fluid jet is generated or a combination of two nozzles with which two primary jets which collide to form a layered flow structure are generated, as is known, for example, from [6].

With the individual nozzle, a single liquid jet is generated in the vertical direction, typically with a circular cross-section and a diameter of less than 2 mm, preferably less than 0.5 mm, particularly preferably less than 0.1 mm, such as, for example, 0.01 mm to 0.1 mm.

The primary jets are preferably generated with an angle a which is selected in the range from 1° to 179°, preferably 10° to 150°, particularly preferably 15° to 120°, such as, for example, 20° to 90°. A flow speed of the primary jets in the range from 0.5 m/s to 100 m/s, particularly preferably 2 m/s to 70 m/s, such as, for example, 5 m/s to 60 m/s or 10 m/s to 50 m/s has been shown to be advantageous. The diameter of the primary jets is preferably selected in the range from 0.01 mm to 0.5 mm, particularly preferably 0.05 mm to 0.4 mm, such as, for example, 0.02 mm to 0.3 mm or 0.03 mm to 0.1 mm. Layered flow structures with at least one minimum curvature which have a constriction in the further course of the jet after the formation of the layered flow structure can be advantageously generated with these parameters. At the location of the constriction, the diameter of the liquid jet can be less than 2 mm, preferably less than 0.5 mm, particularly preferably less than 0.1 mm, such as, for example, 0.01 mm to 0.1 mm. The nozzles of the nozzle device and the inlet opening of the collecting vessel are particularly preferably arranged so that the inlet opening is located at the location of the constriction of the liquid jet.

A further important advantage of the invention lies in the fact that an elevated pressure, preferably atmospheric pressure under normal conditions, is present in the liquid reservoir in comparison to the pressure in the vacuum chamber. The transport of the liquid into the liquid reservoir and the provision of the liquid at the nozzle device are thus simplified.

According to the preferred application of the invention in the case of the provision of a liquid jet for irradiation with electromagnetic radiation or particle radiation, the jet-generation apparatus is preferably provided with an irradiation device. The irradiation device comprises, for example, an X-ray source, a laser source or an electron beam source. The electromagnetic radiation or particle radiation can be generated in the vacuum chamber and supplied directly to the liquid jet. Alternatively, a coupling-in of electromagnetic radiation can be provided from a source arranged outside the vacuum chamber into the interior of the vacuum chamber.

### BRIEF DESCRIPTION OF THE DRAWING

Further details and advantages of the invention are described below with reference to the enclosed drawing. In the drawing:

FIG. 1 shows a schematic illustration of preferred features of the jet generation according to the invention.

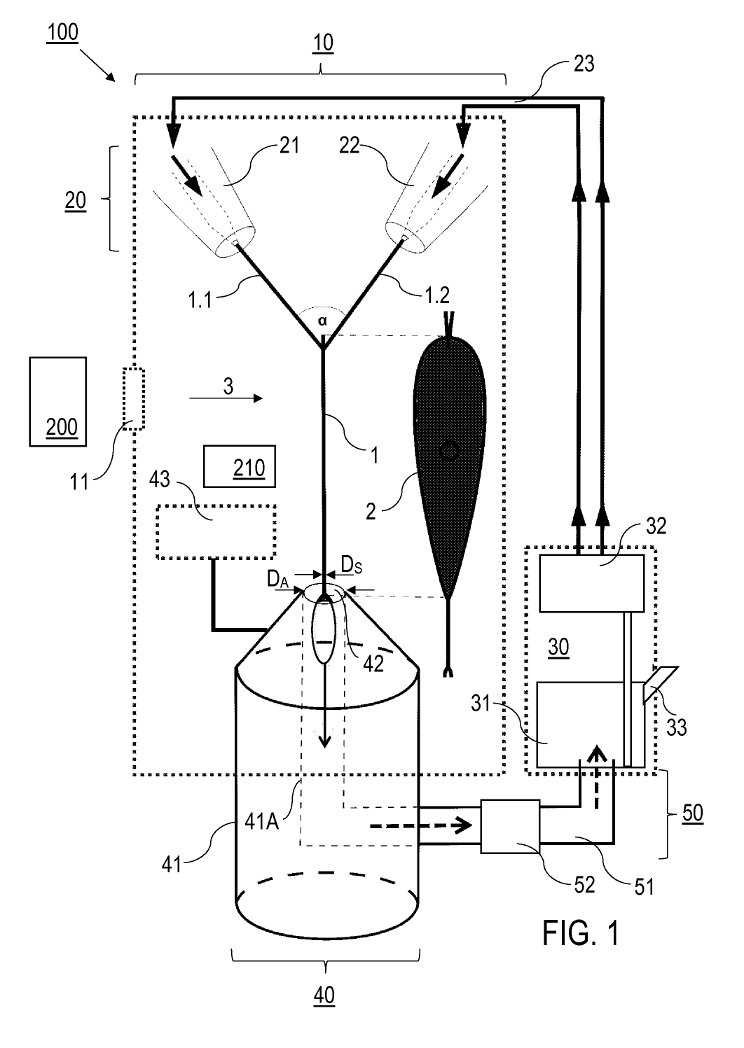

Features of preferred embodiments of the jet-generation apparatus according to the invention and of the method for generating a liquid jet are described with reference by way of example to jet generation with two colliding primary jets. It is emphasized here that the implementation of the invention in practice is not restricted to this variant of jet generation, rather is correspondingly possible with the generation of the liquid jet with one single nozzle. It is furthermore emphasized that FIG. 1 is a schematic illustration which illustrates in particular features of the recovery device. The concrete configuration of the jet-generation apparatus can be selected by the person skilled in the art as a function of the concrete application of the invention, such as is known, for example, from conventional techniques.

According to FIG. 1, jet-generation apparatus 100 comprises vacuum chamber 10, nozzle device 20, liquid supply device 30, collecting device 40 and recovery device 50. An irradiation device 200 and a detector device 210 are also shown schematically which can be coupled to jet-generation apparatus 100 for preferred applications of the invention. Jet-generation apparatus 100 is furthermore provided with a control device and a sensor device (not shown) in order to monitor jet generation and recovery with sensors and control operating parameters of the jet-generation apparatus and, where applicable, irradiation device 200 and detector device 210.

Vacuum chamber 10 is, for example, a stainless steel recipient which is provided with a vacuum pump (not shown) and a coupling-in window 11, for example, for coupling in of laser radiation. Vacuum chamber 10 is configured for an operating pressure, for example, below 10 mbar.

Nozzle device 20 comprises two nozzles 21, 22 which open into vacuum chamber 10. Nozzles 21, 22 are connected via high-pressure connection lines 23 to liquid supply device 30. Each of nozzles 21, 22 has an axial jet direction. When liquid is applied to the high-pressure connection lines 23, primary jets 1.1, 1.2 arise along the jet directions from nozzles 21, 22. Nozzles 21, 22 are arranged so that primary jets 1.1, 1.2 form the same angle with the vertical direction and collide at an angle α. With the collision, liquid jet 1 is formed which extends in a plane perpendicular to the plane spanned by primary jets 1.1, 1.2 as a flat flow structure 2 (see schematic top view perpendicular to the drawing plane in the inserted partial image of FIG. 1). Flow structure 2 forms a portion of liquid jet 1 with a minimal radius of curvature which is configured for particularly effective irradiation 3 with irradiation device 200.

Liquid supply device 30 comprises a storage vessel 31 which is connected to first pump 32 (high-pressure pump). The liquid can be pumped out of storage vessel 31 via high-pressure connection lines 23 to nozzles 21, 22 with first pump 32. First pump 32 comprises, for example, an HPLC pump which is configured for generating a working pressure in the high-pressure connection lines 23 of up to 50 MPa. Liquid supply device 30 furthermore comprises a refilling connection 33, via which liquid medium, for example, the liquid for generating liquid jet 1, additional sample substance and/or a further solvent can be introduced into the storage vessel 31. Since normal pressure prevails in liquid supply device 30, in particular in storage vessel 31, refilling connection 33 can comprise a simple, closable line coupler.

Collecting device 40 comprises collecting vessel 41 with inlet opening 42 and heat pipe heating device 43. Collecting vessel 41 has, for example, the configuration of a hollow cylinder with a truncated cone-shaped cover, the open upper side of which forms inlet opening 42. Collecting vessel 41 is arranged fully or partially in vacuum chamber 10, wherein at least inlet opening 42 is positioned inside vacuum chamber 10. Inlet opening 42 with a diameter D_{A} from 0.05 mm to 0.7 mm is located in the extended jet direction of liquid jet 1 at a position at which flow structure 2 has a constriction. Liquid jet 1 advantageously has at the position of inlet opening 42 its minimum diameter D_{S} which corresponds to 1.5 times the diameter of the primary jets, which results in values between 0.015 mm and 0.15 mm for primary jets from 0.01 mm to 0.1 mm so that the inner diameter of inlet opening 42 can also be minimized. A pressure above 6 mbar is present in collecting vessel 41.

Collecting vessel 41 is manufactured from a non-magnetic material, for example, from copper, titanium, a plastic, in particular a thermally stable plastic, or ceramic. Heat pipe heating device 43 comprises a heat pipe circuit and a heating source. The heat pipe cycle is formed, for example, by copper tubules which are fixedly connected to the wall of collecting vessel 41, preferably in the surroundings of inlet opening 42. For example, an oil is used as the heating medium.

Recovery device 50 comprises a return line 51 which connects collecting vessel 41 to storage vessel 31. Return line 51 contains second pump 52 with which liquid is transported from collecting vessel 41 into storage vessel 31. For example, a peristaltic pump 42 of the MAXIFLOW type (manufacturer: Lambda Instruments) is used.

Alternatively to cylindrical collecting vessel 41, a hose-shaped collecting vessel 41 A (shown by a dashed line) can be provided which is connected directly to return line 51. In the case of this embodiment of the invention, collecting device 40 and recovery device 50 are a common module, comprising a flexible hose or a pipe which extends from vacuum chamber 10 to liquid supply device 30, in particular into liquid reservoir 31 and into which second pump 52 is integrated outside vacuum chamber 10. The opening of the hose or pipe on the side of vacuum chamber 10 forms inlet opening 42 for receiving liquid jet 1. Collected liquid is pumped through the hose or the pipe via second pump 52 directly into storage vessel 31.

In a concrete application, jet-generation apparatus 100 is configured for photoelectron spectroscopy tests on aqueous solutions of a biological sample. The aqueous solution of the biological sample forms the liquid for generating liquid jet 1. Irradiation apparatus 200 comprises a laser source, the radiation of which is coupled into vacuum chamber 10 via the coupling-in window 11 and directed at flow structure 2 of liquid jet 1. The induced photoelectrons are detected and evaluated in a manner known per se with detector device 210. Liquid jet 1 is collected during operation of the jet-generation apparatus with collecting vessel 41 and pumped via return line 51 by means of second pump 52 continuously or intermittently into liquid reservoir 31 from which the liquid is guided again with first pump 32 via high-pressure connection lines 23 to nozzles 21, 22 for generation of liquid jet 1.

The features of the invention disclosed in the above description, the drawing and the claims can be of significance both individually and in combination or under combination for the achievement of the invention in its various configurations.

What is claimed is:

1. A jet-generation apparatus, which is adapted to generate a liquid jet, comprising
a vacuum chamber,
a nozzle device with at least one nozzle, which is arranged for discharging liquid into the vacuum chamber and for generation of the liquid jet,
a liquid supply apparatus which comprises a liquid reservoir and a first pump and is coupled to the nozzle device,
a collecting device, which comprises a collecting vessel with an inlet opening, which is arranged for collecting the liquid jet in the vacuum chamber, and
a recovery device, which is arranged for recovery of the collected liquid from the collecting vessel, wherein
the recovery device comprises a second pump, which is arranged between the collecting vessel and the liquid reservoir and is adapted for transporting the collected liquid directly into the liquid supply device.

2. The jet-generation apparatus according to claim 1, wherein the second pump comprises a peristaltic pump.

3. The jet-generation apparatus according to claim 1, wherein the second pump is arranged at a height at or above a height of the liquid reservoir in relation to a gravitational direction.

4. The jet-generation apparatus according to claim 1, with at least one of the features
a ratio of an inner diameter of the inlet opening to an outer diameter of the liquid jet provided by the nozzle device is less than 10 and greater than 1, and
the collecting vessel has a cylinder or hose shape.

5. The jet-generation apparatus according to claim 1, with at least one of the features
the collecting vessel is connected to a heat pipe heating device, with which the inlet opening can be temperature-controlled, and
the collecting vessel is composed of a non-magnetic material.

6. The jet-generation apparatus according to claim 1, wherein the liquid supply device has a refilling connection via which the liquid reservoir can be refilled with a liquid medium.

7. The jet-generation apparatus according to claim 1, which is provided with an irradiation device for exposing the liquid jet to electromagnetic radiation.

8. A method for generating a liquid jet with a jet-generation apparatus according to claim 1, comprising the steps
supplying a liquid from the liquid supply device to the nozzle device,
generating the liquid jet with the nozzle device in the vacuum chamber,
collecting the liquid jet with the collecting vessel of the collecting device, and
recovering the collected liquid from the collecting vessel, comprising a transport of the collected liquid from the collecting vessel with the second pump directly into the liquid supply device.

9. The method according to claim 8, wherein the inlet opening of the collecting vessel is temperature-controlled with a heat pipe heating device.

10. The method according to claim 8, wherein a liquid medium is supplied via the refilling connection into the liquid reservoir.
